(19) United States
(12) Patent Application Publication
(10) Pub. No.: US 2010/0316843 A1
(43) Pub. Date: Dec. 16, 2010

(54) POLYMER FILM COMPRISING ROUGHENING MATERIAL

(76) Inventors: Lih-Long Chu, Midland, MI (US); Allen W. Ross, Midland, MI (US); Robert L. McGee, Midland, MI (US)

Correspondence Address: The Dow Chemical Company, P.O. BOX 1967, Midland, MI, 48641, US

(21) Appl. No.: 12/781,018

(22) Filed: May 17, 2010

Related U.S. Application Data
(63) Continuation-in-part of application No. 12/470,158, filed on May 21, 2009.

(51) Int. Cl. C09J 7/00; B32B 27/20; C09J 7/02

(52) U.S. Cl. 428/143

(57) ABSTRACT

The present invention is directed to a multilayer polymer film for application to and removal from a substrate, having controlled surface adhesion and peelably removable from a surface, the film having a layer comprising components (A) at least one polyolefin, (B) an adhesive composition in an amount equal to or greater than 3 weight percent, (C) a tackifier composition in an amount of from 1 to 12 weight percent, (D) at least one colorant in an amount from 0 to 15 weight percent, (E) anti-block additive in an amount of less than 1 weight percent, and (F) roughening material in an amount of less than or equal to 20 weight percent, each based on total weight of the adhesive layer; the components (A) through (F) with optional incidental carriers and additives being 100 percent by weight of the adhesive layer; wherein the adhesive composition consists essentially of ethylene/methyl acrylate and ethylene/acrylic acid in a weight ratio of from 60:40 to 50:15, that is, 77:23, ethylene/methyl acrylate to ethylene/acrylic acid; the tackifier is selected from a terpene phenolic resin or an acrylic hot melt resin; and the roughening material has an average particle size ranging from 20 to 60 microns.

### CROSS REFERENCE TO RELATED APPLICATIONS

This application is a continuation-in-part of commonly-owned U.S. patent application Ser. No. 12/470,258, filed on May 21, 2009, hereby incorporated by reference in its entirety.

### BACKGROUND OF THE INVENTION

1. Field of the Invention

The present invention relates to a polymer film comprising a roughening material, and more particularly to a polymer film for application to and removal from a substrate and comprising a roughening material for controlling the gloss and roughness of the substrate, for example coated substrates or soft substrates.

2. Discussion of the Related Art

Films are used to protect surfaces of articles from damage during fabrication, storage, transportation and use. For example, films are used to protect surfaces such as painted wood, painted metal, and soft or malleable materials such as certain plastics. Films of the related art do not protect painted surfaces, such as incompletely dried painted surfaces, or soft plastics from glossing up due to exposure to pressure and/or variations in temperature that may occur during fabrication, storage, transportation and use. Characteristics such as surface temperature, paint composition and surface texture change under the film which may cause the surface to be adversely affected and appear uneven with respect to gloss. For example, surfaces which are desired to have a low-gloss or matte surface may have areas of higher gloss. The formation of the areas of higher gloss is also known as gloss-up, which is considered to be a defect. Accordingly, there exists a need for a film that preferably reduces the gloss-up of the surface to which the film is applied. Also, there exists a need for a film that preferably controls the roughness of the surface to which the film is applied.

### SUMMARY OF THE INVENTION

Accordingly, the present invention, in a first embodiment, is directed to a polymer film comprising a roughening material that substantially obviates one or more problems due to limitations and disadvantages of the related art. In a second embodiment, it is directed to a multilayer film having adhesiveness which film permits adhesion to and removal from a substrate.

An advantage of the present invention, in its first embodiment, is to provide a monolayer film having a roughening material that minimizes gloss-up on a substrate during fabrication, processing, stacking, handling, shipping, storage, packaging and/or installation of the substrate.

Another advantage of the present invention, in its first embodiment, is to provide a multilayer film having a roughening material that minimizes gloss-up on a substrate during fabrication, processing, stacking, handling, shipping, storage, packaging and/or installation of the substrate.

An advantage of the present invention in its second embodiment, is that it can be used to adhere to substrates long enough to protect them, and then be removed, preferably without leaving undesirable residue.

Additional features and advantages of the invention will be set forth in the description which follows, and in part will be apparent from the description, or may be learned by practice of the invention. The advantages of the invention will be realized and attained by the structure particularly pointed out in the written description and claims hereof as well as the appended figures.

To achieve these advantages in the first embodiment, and in accordance with the purpose of the invention, as embodied and broadly described herein, a thermoplastic polymer film comprising a base polyolefin, and a roughening material present in an amount of equal to or greater than about 3 weight percent, based on total weight of the polymer film, wherein the roughening material has an average particle size ranging from about 20 to about 60 microns is disclosed.

To achieve these advantages in the second embodiment, and in accordance with the purpose of the invention, as embodied and broadly described herein, a multilayer polymer film for application to and removal from a substrate, having controlled surface adhesion and peelably removable from the surface, the film having a layer comprising components (A) at least one polyolefin, (B) an adhesive composition in an amount equal to or greater than 3 weight percent, (C) a tackifier composition in an amount of from 1 to 12 weight percent, (D) at least one colorant in an amount from 0 to 15 weight percent, (E) anti-block additive in an amount of less than 1 weight percent, and (F) roughening material in an amount of less than or equal to 20 weight percent, each based on total weight of the adhesive layer; the components (A) through (F) with optional incidental carriers and additives being 100 percent by weight of the adhesive layer; wherein the adhesive composition consists essentially of ethylene/methyl acrylate and ethylene/acrylic acid in a weight ratio of from 60:40 to 50:15, that is, 77:23, ethylene/methyl acrylate to ethylene/acrylic acid; the tackifier is selected from a terpene phenolic resin or an acrylic hot melt resin; and the roughening material has an average particle size ranging from 20 to 60 microns.

It is to be understood that both the foregoing general description and the following detailed description of the present invention are exemplary and explanatory and are intended to provide further explanation of the invention as claimed.

### BRIEF DESCRIPTION OF THE DRAWINGS

FIG. 1 illustrates a multilayer film in accordance with an embodiment of the present invention;

FIG. 2 illustrates a multilayer film in accordance with an embodiment of the present invention; and

FIG. 3 illustrates the effect that a film in accordance with an embodiment of the present invention has on a painted surface.

### DETAILED DESCRIPTION OF THE INVENTION

Reference will now be made in detail to embodiments of the present invention, examples of which are disclosed in the specification. It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

When ranges are stated, the ranges include both endpoints of the range unless otherwise stated.

Numerical ranges include all values from and including the lower and upper values, in increments of one unit, provided that there is a separation of at least two units between any lower value and any higher value. As an example, if a compositional, physical or other property, such as, for example, thickness, density, molecular weight, monomer content, melt flow rate, etc. is greater than 10, it is intended that all individual values, such as 10, 11, 12, etc. and sub ranges, such as 100 to 144, 155 to 170, 197 to 200, etc., are expressly enumerated. For ranges containing values which are less than one or containing fractional numbers greater than one (e.g., 1.1, 1.5, etc.), one unit is considered to be 0.0001, 0.001, 0.01 or 0.01, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered expressly stated in this disclosure.

Roughening Material

The polymer film of the present invention includes a roughening material. The roughening material imparts a roughness to the film. The roughness may be measured using a commercially available surface texture measurement device, as described in the following examples. The amount of roughening material included in the polymer film of the present invention may depend on the amount of gloss-up reduction needed for a substrate in any given application. The amount of surface roughness of the substrate is controlled by application of the polymer film comprising the roughening material on the surface. The amount and type of roughening material should be selected to provide a surface roughness that yields a gloss match with the remaining unaffected surface areas. The application of the polymer film comprising the roughening material mitigates gloss-up of surface areas that are affected by any number of factors, such as the application of pressure and the changing of temperature, that occur during fabrication, processing, stacking, handling, shipping, storage, packaging and/or installation of the substrate.

When the polymer film comprising the roughening material of the present invention is applied to protect substrates, such as planks of building siding that have a painted surface or are made of polyurethane, and there is a pressure or force applied against the film surface, such as where the planks are handled, stacked, packaged, etc., the roughening material creates a roughness through the film onto the substrate that matches the desired overall surface roughness of the substrate. The critical level of roughness created onto the substrate is not sufficiently achieved when a smoother film, such as a film including anti-blocking agents, is applied to the substrate.

Suitable roughening materials can have a range of particulate shapes and structures (e.g., shapes that are generally elongated, generally spherical or generally block) and aspect ratios as long as the roughening material provides the desired substrate surface roughening effects. A suitable roughening material has an elongated structure. Preferred elongated structures include needle-shaped or plated-shaped structures. Suitable roughening materials have an average particle size in the range of (largest dimension) of from about 20 to about 60 microns, preferably about 29 to about 49 microns, more preferably about 33 to about 44 microns. Particularly suitable roughening materials have an average particle size of about 33-46 microns. Suitable roughening materials also have an aspect ratio (largest dimension/smallest dimension) of from about 10 to about 100. A particularly suitable roughening material has an average aspect ratio of about 35.

Any roughening material having the above-identified characteristics and functionalities may be employed in the polymer film of the present invention. The roughening material is preferably an inorganic material. The roughening material may include materials, alone or in combination, such as zeolites, glass, talc, mica, clay, silica, sodium calcium alumino silicates, calcium carbonates, aluminum silicates, sodium silicates, magnesium silicates, calcium silicates and silicon dioxides. Preferably, mica is the roughening material. Theoretically, an incompatible particulate polymer, such as rubber or a cross-linked polymer, may be employed as the roughening material. Preferably, the roughening material is obtained in a compatible carrier for combination into the thermoplastic resin that is used to make the film. Preferably, the roughening material is mica and more preferably it is used in a compatible carrier. For example, a 40 weight percent distribution of mica in high density polyethylene (HDPE) carrier (available from DuPont Canada Inc. under the trade name MICAFIL™40) may be used. Preferably, a 40 weight percent distribution of mica in a linear low density polyethylene (LLDPE) carrier may be employed to combine the roughening material into the polymer film.

The roughening material may be present in an amount of about 3 weight percent, preferably greater than about 4 weight percent, preferably greater than about 5 weight percent, preferably greater than about 6 weight percent, preferably greater than about 7 weight percent and more preferably greater than 8 weight percent, based on total weight of the polymer film. Depending on various factors, such as the desired gloss-up reduction, the roughening material may be present in an amount less than 20 weight percent, more preferably less than 18 weight percent, more preferably less than 16 weight percent, based on total weight of the polymer film.

The use of the roughening materials according to the present invention is generally distinguishable from the use of anti-blocking agents, such as those described in U.S. Pat. No. 6,210,764 and U.S. Pat. No. 5,847,042. Anti-blocking agents have a relatively smaller particle size than the roughening materials of the present invention. Anti-blocking agents also are present in a polymer film in lower amounts, typically less than 2 weight percent and more typically less than 1 weight percent, exclusive of carrier. While anti-blocking agents may create microscale protrusions in a film, they do not create a sufficient roughness through the film that transfers to a substrate to which the film is applied. The roughening material creates a sufficient roughness through a polymer film of the present invention onto a substrate that matches the desired overall surface roughness for the substrate.

Protective Roughening Films

The protective roughening films according to the invention can be constructed and used as a number of different optional film structures (as discussed further below) and using a range of different thermoplastic resin materials that will provided desired film performance for the intended applications. In general the desired film performance features are: (a) sufficient physical properties needed for application of the film, surface protection during any handling/shipping and film removal; (b) controlled surface adhesion to remain fixed to the substrate surface, be peelably removable from the surface, and maintain film surface integrity during removal to avoid leaving an unacceptable adhesive residue and (c) cost effective types and amounts of the thermoplastic resin film components.

For providing these and other film performance features, the polymer film preferably comprises a layer that further comprises a base polyolefin resin which is defined herein as a polyolefin or a blend of such polyolefins having a density of from about 0.87 g/cm³ to about 0.96 g/cm³ and a melt index of about 0.25 to about 8. As used herein, the term “polyolefin” includes copolymers and the term “copolymer” refers to polymers having at least two different monomers polymerized therein. Polyolefins include polymers and copolymers of any number of alpha-olefins, including but not limited to, ethylene, propylene, isobutylene, 1-butene, 1-pentene, 1-hexene, 1-heptene, 1-octene, 1-nonene, 1-decene, 1-dodecene, 1-tetradecene, 1-hexadecene, 1-octadecene, 1-eicosene, 3-methyl-1-butene, 3-methyl-1-pentene, 4-methyl-1-pentene, 4,6-dimethyl-1-heptene, and vinylcyclohexane.

Preferably, the polymer film of the present invention may comprise at least one polyolefin or blends of two or more polyolefins selected from the group of well known polyolefins including but not limited to linear low density polyethylene (LLDPE), ultra low density polyethylene (ULDPE), low density polyethylene (LDPE), high density polyethylene (HDPE), polypropylene homopolymer (PP), propylene copolymer (either random, mini-random or impact copolymers), m-LLDPE, polypropylene, ethylene-propylene copolymer, homogeneous ethylene/alpha-olefin (EAO) copolymer, metallocene-catalyzed EAO copolymer or a substantially linear ethylene alpha-olefin (SLEP) copolymer wherein the alpha olefin contains from 3 to 20 carbon atoms. The polymer film of the present invention may alternatively, or additionally, comprise at least one polyolefin from the group including but not limited to ethylene/alkyl acrylate copolymers, ethylene/α,β-ethylenically unsaturated carboxylic acid copolymers, ethylene vinyl acetate, and blends of two or more of these polyolefins.

HDPE is a polyethylene that is commonly employed in the art with a density (ρ) of at least (≧) 0.94 grams per cubic centimeter (g/cm³).

ULDPE is a polyethylene commonly employed in the art typically having a density (ρ) of from 0.90 to 0.92 g/cm³. Suitable ULDPE include ULDPE available from The Dow Chemical Company under the trade name ATTANE™.

LDPE is a polyethylene having a density of from about 0.91 to about 0.94 g/cm³ produced using radicals, for instance from oxygen or peroxide catalysts, at high pressure. Suitable LDPE include LDPE commercially available from The Dow Chemical Company under the trade designations 6811.

LLDPE (as distinguished from LDPE) is a homopolymer or copolymer of ethylene and with at least one α-olefin containing from 3 to 20 carbon atoms (C₃₋₂₀), made using transition metal catalysts and having a density from 0.915 to 0.93 g/cm³. Suitable α-olefins are aliphatic α-olefins containing from 3 to 20, preferably from 3 to 12, more preferably from 3 to 8 carbon atoms (C₃₋₂₀, C₃₋₁₂, C₃₋₈). As used herein, subscripts indicate the number of, for example carbon (C) atoms contained in a monomer. Particularly suitable alpha-olefins include ethylene, propylene, butene-1,4-methyl-1-pentene, hexene-1 or octene-1, or ethylene in combination with one or more of propylene, butene-1,4-methyl-1-pentene, hexene-1 and octene-1. Where LDPE has long chain branches as a result of the radical polymerization, the LLDPE is linear except for short chain branches that come from the comonomers.

SLEPs display densities as low as 0.87 g/cm³. Suitable SLEPs for use in the present invention have densities of at least 0.88 g/cm³ and may have densities of at least 0.89 g/cm³. The Dow Chemical Company produces and sells SLEP polymer resins made using INSITE® constrained geometry catalysts under the trade designation AFFINITY™. U.S. Pat. Nos. 5,272,236; 5,278,272 and 5,346,963, the disclosures of which are herein incorporated by reference, detail preparation of SLEPs.

Polypropylene (PP) homopolymers and propylene copolymers provide satisfactory results when used as the linear polyolefin resin. U.S. Pat. No. 5,527,573 discloses suitable propylene polymer materials at column 3, lines 27-52, the teachings of which are incorporated herein by reference. The propylene polymer materials include (a) propylene homopolymers, (b) random and block copolymers of propylene and an olefin selected from ethylene, 1-olefins (α-olefins) containing 4 to 10 carbon atoms (C₄₋₁₀) and C₄₋₁₀ dienes, and (c) random terpolymers of propylene and two monomers selected from ethylene and C₄₋₁₀ α-olefins. The C₄₋₁₀ α-olefins may be linear or branched, but are preferably linear. Suitable propylene polymer materials have a melt flow rate or MFR (ASTM D-1238, Condition 230° C./2.16 kilograms (kg)) of 0.01-100 grams per ten minutes (g/10 min), preferably 0.01-50 g/10 min, more preferably 0.05-10 g/10 min, and still more preferably 0.1 to 3 g/10 min.

Optionally (and preferably for desired controlled adhesion properties), the polymer film may comprise a composition that imparts adhesive characteristics to the polymer film, either mixed with the polyolefin base resin, or as a separate layer. Exemplary compositions that impart adhesive characteristics include copolymers of ethylene and vinyl acetate; ethylene/alkyl acrylate copolymers; ethylene/α, β-ethylenically unsaturated carboxylic acid copolymers and blends of two or more of these components.

The alkyl acrylate is preferably selected from the group consisting of methyl acrylate, butyl acrylate and 2-ethylhexyl acrylate. Two or more ethylene/alkyl acrylate copolymers may be blended to yield a desired total alkyl acrylate content. Alkyl acrylate content is preferably in the range of 18 to 29 weight percent, and most preferably 28 weight percent, based on total weight of the copolymer. Adhesion properties may be increased by increasing the alkyl acrylate content in the copolymer. If the alkyl acrylate is methyl acrylate, the methyl acrylate is present in amount of from 26 to 31 weight percent, based on copolymer weight. The ethylene/methacrylate copolymer preferably has a melt index in the range of about 2 to 7. If the alkyl acrylate is butyl acrylate, the butyl acrylate is present in amount of from 33 to 37 weight percent, based on copolymer weight. If the alkyl acrylate is 2-ethylhexyl acrylate, the 2-ethylhexyl acrylate is present in amount of from 34 to 38 weight percent, based on copolymer weight. With alkyl acrylate amounts lower than the amounts stated, the copolymers tend to be more crystalline. With alkyl acrylate amounts greater than the amounts stated, the copolymers tend to become liquid and lose their solid resinous character. Arkema produces and sells ethylene/methyl acrylate copolymers under the trade name LOTRYL™.

Preferred ethylene/α, β-ethylenically unsaturated carboxylic acid copolymers include ethylene/acrylic acid (EAA) copolymers and ethylene/methacrylic acid (EMAA) copolymers with EAA copolymers being especially preferred.

The acrylic acid (AA) in the EAA copolymers is present in an amount of from 3 to 22 weight percent, based upon copolymer weight. The AA is more preferably present in an amount of from 6 to 22 weight percent, and more preferably from 9 to 22 weight percent, based on copolymer weight. Two or more EAA copolymers may be blended to provide a desired AA content. An AA content less than 3 weight percent yields inadequate adhesive properties and a higher melting point which may make the product including the polymer blend more difficult to apply and would likely have poorer peel strength at room temperatures and/or low temperatures, such as storage room temperatures. An AA content greater than 22 weight percent is generally not available commercially. The Dow Chemical Company produces and sells EAA copolymers with an AA content of 5 weight percent to 20.5 weight percent as well as EAA copolymer blends under the trade name PRIMACOR™.

Optionally, the polymer films of the present invention may contain various additives. Additives may be included in the polymer blends in amounts that do not substantially affect the desirable properties, such as adhesive properties and peelability characteristics, of the polymer films. Exemplary well-known additives include ultraviolet (UV) stabilizers, UV absorbers, antioxidants, anti-blocks, colorants, tackifiers, etc. Tackifiers and colorants may be present in an amount of from 0 to 15 weight percent, based on the total weight of the polymer film. Other additives, such as UV stabilizers, UV absorbers, antioxidants, anti-blocks, etc. may be present in an amount of less than about 2 weight percent, based on total weight of the polymer film.

Monolayer Film

When providing the films according to the present invention in the form of a simplified, single layer structure combining the features of roughening material, desired level of adhesion and cost effectiveness, it has been found that the base polyolefin may be present in an amount of from 1 to 93 weight percent, based on the total weight of the base polyolefin, roughening material and optional adhesive composition in the polymer film. Preferably, the base polyolefin may be present in an amount greater than 8 weight percent, more preferably greater than 40 weight percent, more preferably greater than 60 weight percent, and most preferably greater than 80 weight percent, based on the total weight of the base polyolefin, roughening material and optional adhesive composition in the polymer film. Based on factors, such as cost considerations, the base polyolefin may be present in an amount less than 80 weight percent, preferably less than 85 weight percent, preferably less than 87 weight percent, more preferably less than 90 weight percent, more preferably less than 92 weight percent and more preferably less than 93 weight percent, based on the total weight of the base polyolefin, roughening material and optional adhesive composition in the polymer film. In an embodiment, the monolayer film comprises 92 weight percent polyolefin and 8 weight percent roughening material.

The base polyolefin may preferably comprise a blend of polyolefins. The blend is preferably provided in amounts that avoid self adhesion of the polymer film. The blend may be provided with components having sufficiently high melting points that prevent sticking to a hot surface, such as a hot lamination roller. The base polyolefin may preferably be a blend of LDPE, LLDPE, ULDPE, metallocene-catalyzed EAO copolymer and/or SLEPs, wherein the blend imparts a total density of 0.87 to 0.93 g/cm³ to the polymer film. Preferably, the blend imparts a total density of less than 0.92 g/cm³, preferably less than 0.89 g/cm³ and preferably less than 0.88 g/cm³ to the polymer film. In an embodiment, the polymer film preferably contains a blend of 25 weight percent metallocene-catalyzed LLDPE and 75 weight percent of a LDPE/LLDPE blend, based on the base polyolefin weight in the polymer film. The LDPE/LLDPE blend may be provided in any combination, however the LDPE/LLDPE blend may be LLDPE-rich, and may include 20 to 25 weight percent LDPE and 50 weight percent LLDPE, based on the base polyolefin weight in the polymer film.

In a monolayer embodiment, the film may comprise, for desired controlled adhesion properties, a composition that imparts adhesive characteristics to the polymer film. Exemplary compositions that impart adhesive characteristics are discussed above and include copolymers of an ethylene/vinyl acetate, an ethylene/alkyl acrylate copolymer, an ethylene/β, β-ethylenically unsaturated carboxylic acid copolymer, or a blend of two or more of these components. The ethylene/vinyl acetate, ethylene/alkyl acrylate copolymer, ethylene/α, β-ethylenically unsaturated carboxylic acid copolymer, or blend of two or more of these components, may be present in an amount of from 0 weight percent to 93 weight percent, based on total weight of the polymer film. The adhesive composition may preferably be present in an amount equal to or greater than 3 weight percent, more preferably equal to or greater than 10 weight percent, more preferably equal to or greater than 15, and more preferably equal to or greater than 20 weight percent, based on total weight of the polymer film. The adhesive composition may be present in an amount equal to or greater than 25 weight percent, based on total weight of the polymer film. Depending on factors, such as desired polymer blend properties and manufacturing costs, the adhesive composition may preferably be present in an amount equal to or less than 75 weight percent, more preferably equal to or less than 50 weight percent, more preferably equal to or less than 40 weight percent, and more preferably equal to or less than 30 weight percent, based on the total weight of the polymer film.

In a monolayer embodiment, the roughening material may be present in an amount of about 3 weight percent, preferably greater than 4 weight percent, preferably greater than 5 weight percent, preferably greater than 6 weight percent, preferably greater than 7 weight percent, and more preferably greater than 8 weight percent, based on total weight of the polymer film. Depending on various factors, such as the desired gloss-up reduction and manufacturing costs, the roughening material may be present in an amount less than 20 weight percent, more preferably less than 19 weight percent, more preferably less than 18 weight percent, more preferably less than 17 weight percent, and more preferably less than 16 weight percent, based on total weight of the polymer film.

Multilayer Film

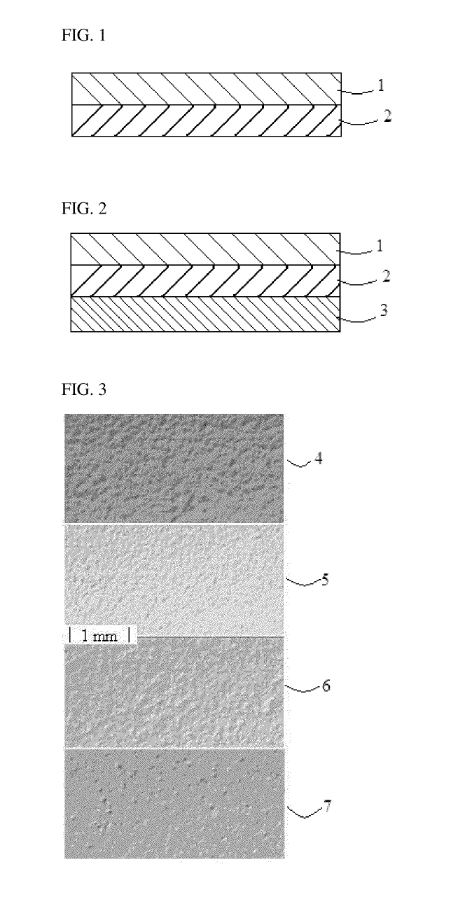

Optionally, the polymer film comprising the roughening material is a multilayer film where the layers may be provided to make more cost effective use of base polyolefin, roughening material and adhesive components. The multilayer film of at least two layers may include separate layers for locating the roughening material and the adhesive composition and optionally additional layers, preferably at least one additional optional backing layer. In one embodiment, one of the additional layers may preferably be a separate adhesive layer comprising the adhesive composition described above and another of the optional additional layers may be a backing layer comprising a polyolefin or a blend of polyolefins, with the layer comprising the base polyolefin and the roughening material sandwiched between the adhesive layer and the backing layer. The optional backing layer may be selected from polyolefins having sufficiently high melting points that prevent sticking of the backing layer to a hot surface, such as a hot lamination roller. When the multilayer film is a two-layer film comprising the adhesive layer and the polymer film (including the base polyolefin and roughening material), the multilayer film has the structure as shown in FIG. 1 (not drawn to scale). FIG. 1 illustrates a co-extruded multilayer film having an adhesive layer 1 and polymer film layer 2. When the multilayer film is a three-layer film comprising the adhesive layer, the polymer film, and the backing layer, the multilayer film has the structure as shown in FIG. 2 (not drawn to scale). FIG. 2 illustrates a co-extruded multilayer film having an adhesive layer 1, polymer film layer 2 and backing layer 3.

When the multilayer film is a two-layer film, the polymer film layer (including the base polyolefin and roughening material) preferably comprising the same type and amounts of roughening material components and polyolefin components described above with respect to the monolayer embodiment. In a two-layer multilayer film, the polymer film layer preferably does not comprise an adhesive composition.

The adhesive composition is present in the adhesive layer, the second layer in the multilayer film. Exemplary adhesive composition in the adhesive layer include copolymers of an ethylene/vinyl acetate, an ethylene/alkyl acrylate copolymer, an ethylene/α, β-ethylenically unsaturated carboxylic acid copolymer, or a blend of two or more of these components. The ethylene/vinyl acetate, ethylene/alkyl acrylate copolymer, ethylene/α, β-ethylenically unsaturated carboxylic acid copolymer, or blend of two or more of these components may be present in an amount of from 80 weight percent to 100 weight percent, based on total weight of the adhesive layer. The adhesive composition may preferably be present in an amount equal to or greater than 90 weight percent, more preferably equal to or greater than 93 weight percent, more preferably equal to or greater than 95 weight percent, more preferably equal to or greater than 98 weight percent and more preferably greater than or equal to 99 weight percent, based on total weight of the adhesive layer. Less than one percent anti-block additive may be included in the adhesive layer. The adhesive layer may optionally comprise a polyolefin or a blend of polyolefins as described above. If the adhesive layer comprises polyolefin(s), the adhesive composition is present in the adhesive layer in an amount of equal to or greater than 3 weight percent, more preferably equal to or greater than 10 weight percent, more preferably equal to or greater than 15, and more preferably equal to or greater than 20 weight percent, based on total weight of the adhesive layer. Optionally, the adhesive layer may also comprise roughening material. When present, the roughening material is present in an amount less than or equal to 20 weight percent. Preferably, the roughening material may be present in an amount less than 10 weight percent, preferably less than 5 weight percent, more preferably less than 2.8 weight percent, and more preferably less than 0.5 weight percent based on the total weight of the adhesive layer.

Optionally, the adhesive layer includes a tackifier composition. Suitable tackifier compositions impart improved adhesive properties to the polymer films of the present invention. The tackifier may be any number of conventional materials used to impart these properties. The tackifier composition is preferably a terpene phenolic resin or an acrylic hot melt resin. When present, the tackifier composition is present in an amount of from 1 weight percent to 12 weight percent, based on total weight of the adhesive layer. The tackifier composition is preferably present in an amount equal to or greater than 2 weight percent, more preferably equal to or greater than 4 weight percent and more preferably equal to or greater than 5 weight percent, based on total weight of the adhesive layer. Depending on factors, such as desired polymer blend properties and manufacturing costs, the tackifier composition is preferably present in an amount equal to or less than 12 weight percent, more preferably equal to or less than 10 weight percent and more preferably equal to or less than 8 weight percent, more preferably equal to or less than 6 weight percent, based on the total weight of the adhesive layer. Preferably, the tackifier is in the form of a thermoplastic terpene phenolic resin. Terpene phenolic resins, i.e., phenolic modified terpene resins and hydrogenated derivatives thereof such, for example, as the resin product resulting from the condensation, in an acidic medium, of a bicyclic terpene and a phenol. The parent phenolic compound is phenol itself. Other phenolic compounds are derivatives of phenol wherein 1 to 3 of the aromatic hydrogens are replaced with an equal number of substituents which may be independently selected from hydroxyl; C₁-C₁₂ alkyl; C₁-C₁₂ alkyl substituted with 1 or 2 groups selected from hydroxyl and phenyl; phenyl; and phenyl substituted with 1 or 2 groups selected from hydroxyl and C₁-C₁₂ alkyl. Specific derivatives of phenol include cresols (including the ortho, meta and para cresols), 1,3,5-xylenols, C₁₋₂₂ alkylphenol, iso-propylphenol, tert-butylphenol, amylphenol, octylphenol, nonylphenol, diphenylolpropane, phenylphenol, resorcinol, cashew nutshell liquid, bisphenol-A and cumylphenol. Phenolic compounds having a single substituent in the para position (relative to the hydroxyl group) include p-tert-butylphenol, p-octylphenol and p-nonylphenol. Hydrogenated derivatives of phenolic modified terpene resins, for example, may be prepared from the condensation, in an acidic medium of a bicyclic terpene and a phenol. Copolymers and terpolymers of natured terpenes, include, for example, styrene/terpene and alpha methyl styrene; polyterpene resins having a softening point, as determined by ASTM method E28-58T, of from about 80° C. to 150° C.; aliphatic petroleum hydrocarbon resins having a Ball and Ring softening point of from about 70° C. to 135° C.; aromatic petroleum hydrocarbon resins and the hydrogenated derivatives thereof; and alicyclic petroleum hydrocarbon resins and the hydrogenated derivatives thereof may be used in combination with terpene phenolic resins. Arizona Chemical produces a suitable terpene under the trade name SYLVARES® and Ampacet produces a concentrate having 30 weight percent terpene in low density polyethylene under the name AMPACET™ 103233.

In another embodiment, an alternative tackifier may be in the form of an acrylic hot melt resin. Rohm& Haas produces a suitable acrylic hot melt resin under the trade name PARALOID™ B-72 acrylic hot melt resin.

When the multilayer film is a three-layer film, the polymer film layer (including the base polyolefin and roughening material) preferably comprising the same type and amounts of roughening material components and polyolefin components described above with respect to the monolayer embodiment and preferably does not comprise an adhesive composition. In a three-layer film, the adhesive layer preferably comprises the same type and amounts of components described above with respect to a two-layer multilayer film. An optional backing layer is present in a three-layer multilayer film.

When present, the backing layer includes any one or more of the polyolefins described above for the polymer film. The backing layer may comprise at least about 45 weight percent, more preferably at least about 55 weight percent, more preferably at least about 65 weight percent and more preferably at least about 75 weight percent HDPE, based on total weight of the backing layer. The backing layer may additionally comprise at least about 45 weight percent, more preferably at least about 35 weight percent, and more preferably at least about 25 weight percent any number of the polyolefins described above including but not limited to LDPE, LLDPE, SLEPs, and metallocene-catalyzed polyolefins. Alternatively, the backing layer may comprise roughening material. When present, the roughening material is present in an amount less than or equal to 20 weight percent, more preferably less than 15 weight percent, more preferably less than 10 weight percent, more preferably less than 5 weight percent, more preferably less than 3 weight percent, more preferably less than 2 weight percent, and more preferably less than 1 weight percent, based on the total weight of the backing layer.

When present, the backing layer and/or the adhesive layer may include various polyolefins and/or additives described above for the polymer films of the present invention. Polyolefins and/or additives may be included in each of the backing layer and the adhesive layer in amounts that do not substantially affect the desirable properties of each of the layers.

In a two-layer multilayer film embodiment of the present invention, the adhesive layer comprises 5 weight percent of the roughening material concentrate (corresponding to about 2 weight percent roughening material), 50 weight percent EMA, 15 weight percent EAA, 15 weight percent AFFINITY™ polyolefin, and 15 weight percent tackifier terpene concentrate (corresponding to a 5 weight percent terpene amount), based on based on total weight of the adhesive layer. In a two-layer embodiment, the polymer film layer comprises 8 weight percent of the roughening material, and 92 weight percent polyolefin blend (including 12 weight percent of LLDPE carrier for the roughening material), based on total weight of the polymer film layer. In an embodiment, the polyolefin blend comprises 20 weight percent LDPE and 60 weight percent LLDPE, based on total weight of the polyolefin blend. In a three-layer multilayer film embodiment of the present invention, the optional backing layer comprises 75 weight percent HDPE, 24 weight percent LDPE and one percent antioxidant additive to prevent gel formation, based on the total weight of the backing layer.

The multilayer film may be manufactured using conventional co-extrusion techniques. As used herein, “co-extrusion,” “co-extrude,” and the like refer to the process of extruding two or more materials through a single die with two or more orifices arranged so that the extrudates merge and weld together into a laminar structure before cooling or chilling, i.e., quenching. Co-extrusion is often employed as an aspect of other processes, for instance, in blown film and cast film processes.

FILM EXTRUSION MANUAL, Process Materials, Properties, prepared by the Film Extrusion Committee of the Polymers, Laminations and Coatings Division, TAPPI, and edited by Thomas I. Butler and Earl W. Veazey, TAPPI Press, 1992, particularly in Chapter 3, discusses film extrusion processes, particularly blown film and cast film processes. The teachings of this manual are incorporated herein to the maximum extent permitted by law. Both processes permit recycling of scrap film and edge trim to maximize use of polymer. Blown film production involves extruding molten polymer through an annular opening to form a hot tube of polymer. The tube is then cooled and collapsed into an envelope shape. By way of contrast, cast film is extruded through a flat die with a thin wide opening. The flat curtain of film is cooled rapidly and then sent on for further processing.

Extrusion provides an even, consistent flow of polymer melt to a forming die and uses, what may also be referred to as a screw pump that includes a constant diameter screw, to convey polymer from a feed port to a discharge end. By adding energy to the polymer in the form of shear and heat, one melts the polymer. Polymer compression occurs as extruder screw root diameter increases toward the discharge end.

In a blown film bubble process, a quantity of air is injected into the center of the hot tube of polymer to inflate it to a desired diameter. Prior to inflation, the tube has a typical thickness that ranges from 0.028 inch (0.7 millimeter (mm)) to over 0.1 inch (2.5 mm). After the inflated tube is cooled and collapsed into an envelope shape, it passes through a set of nip rolls before it is slit and wound up.

In the cast film process, extrudate from the die has a thickness that typically ranges from 0.01 inch (0.25 mm) to 0.025 inch (0.63 mm). In chill roll cast extrusion, the extrudate is cast directly onto a polished roll that is chilled via an internal cooling mechanism. An air knife may be used to ensure contact of the extrudate with the chill roll and provide additional cooling.

Individual layer thickness, while not particularly critical, can be chosen to control manufacturing costs, or one or more physical or mechanical properties of the layer. Components of the adhesive layer tend to have a higher raw material cost. This factor alone motivates one to use an adhesive layer that functions as an adhesive, yet is as thin as possible providing the desired adhesive characteristics. For a two-layer multilayer film, the polymer film layer ranges from 50 to 95 volume percent and the adhesive layer ranges from 5 to 50 volume percent of the total film. Based on total film thickness, the polymer film layer preferably ranges from 75 to 90 volume percent and the adhesive layer preferably ranges from 10 to 25 volume percent. More preferably, the polymer film layer ranges from 85 to 90 volume percent and the adhesive layer ranges from 10 to 15 volume percent, based on total thickness of the two-layer multilayer film. The thickness of the other layers, such as the optional backing layer, vary in accordance with the thickness of the polymer film layer to provide other potentially desirable physical properties such as curl, tensile strength, tear properties, or stiffness. For a three-layer multilayer film, the polymer film layer ranges from 50 to 90 volume percent, the adhesive layer ranges from 5 to 25 volume percent, and the backing layer ranges from 5 to 25 volume percent, of the total film. Based on total film thickness, the polymer film layer preferably ranges from 60 to 85 volume percent, the adhesive layer preferably ranges from 10 to 20 volume percent, and the backing layer preferably ranges from 5 to 20 volume percent. More preferably, the polymer film layer ranges from 75 to 80 volume percent, the adhesive layer ranges from 15 to 10 volume percent, and the backing layer ranges from 10 to 20 volume percent, based on total thickness of the two-layer multilayer film. In each instance, select individual layer thicknesses to provide a total of 100%.

Multilayer film structures of the present invention have a total thickness that is preferably within a range of 0.5 mil (0.013 mm) to 5 mil (0.13 mm), more preferably within a range of from 1.5 mil (0.04 mm) to 2.5 mils (0.065 mm), and most preferably within a range of from 1.75 mil (0.045 mm) to 1.9 mils (0.05 mm).

Monolayer film structures of the present invention have a total thickness that is preferably within a range of 0.5 mil (0.013 mm) to 5 mil (0.13 mm), more preferably within a range of from 0.5 mil (0.013 mm) to 1.5 mils (0.04 mm), and most preferably within a range of from 0.8 mil (0.02 mm) to 1.1 mils (0.03 mm).

Films of the present invention are used to protect relatively soft or malleable surfaces of substrates, such as coated wood, coated metal, and soft or malleable plastics, such as polyurethane. As used herein, the term “soft or malleable substrates” that are protected by use of the films according to the present invention include low gloss or matte finish types of substrates that may be somewhat soft and malleable in their initial and final stages or that, in an initial stage, may not yet be fully hardened or set, such as substrates that are thermoplastics or thermosettable plastics, e.g. polyurethane. The surface may be substrate material itself, such as with a plastic article or it may be a coating that is applied. The coating, for example, may be paint or freshly applied paint. The coating is deemed to be soft or malleable where the coated substrate would otherwise be adversely affected, such as by gloss-up, between the time at which the film is initially applied until the film is removed. For example, the coating may gloss-up under conditions of manufacturing, processing, stacking, handling, shipping, storing, packaging, and installation. As used herein, the term low gloss or matte finish means a gloss having a 60 degree gloss value that is less than 75, as measured using ASTM 2457. For example, the gloss may have a 60 degree gloss less than about 50, preferably less than about 35, preferably less than about 30, preferably less than about 25, as measured using ASTM 2457.

Combinations of ethylene/alkyl acrylate copolymer and ethylene/α, β-ethylenically unsaturated carboxylic acid copolymer, preferably with tackifier, as disclosed herein are especially useful in achieving the desired film performance feature of controlled surface adhesion to remain fixed to the substrate surface, be peelably removable from the surface, and maintain film surface integrity during removal to avoid leaving an unacceptable adhesive residue. This feature of the combination is surprising because each of the ethylene/alkyl acrylate copolymer, ethylene/α, β-ethylenically unsaturated carboxylic acid copolymer, and tackifier are known separately to increase adhesion. However, the combination as disclosed herein produces a peelably removable seal with substrates, especially soft malleable substrates such as plastics or coatings, especially paints, all as disclosed herein. Similarly, it is surprising that soft, sticky ethylene/alkyl acrylate copolymer, preferably ethylene/methyl acrylate copolymer, having the desired relatively high alkyl acrylate composition previously disclosed, produces films having the desired removability performance feature.

As used herein, the phrase “machine direction”, abbreviated “MD,” refers to a direction along the length of the film, i.e., in the direction of the film as the film is formed during extrusion and/or coating. As used herein, the phrase “transverse direction”, abbreviated “TD,” refers to a direction across the film, i.e., perpendicular to the MD.

The following examples illustrate, but do not in any way limit, the present invention. Arabic numerals designate examples of the invention and Arabic numerals followed by an asterisk (*) designate comparative examples. All parts and percentages are by weight unless otherwise stated. In addition, all amounts shown in the tables are based on weight of the polymer contained in the respective compositions unless otherwise stated.

### EXAMPLES

### Examples 1-11

Each example is a multilayer film sample created as described. Co-extrude each multilayer film having an AB structure with an overall thickness of 2 mils (50 microns) using a conventional upward blown film line equipped with a 2 inch (in) (5.08 centimeter (cm)) diameter die and 0.75 in. (1.91 cm) extruders. Zone ramp the extruder that feeds layer A from 300° F. to 330° F. Zone ramp the extruder that feeds layer B from 330° F. to 380° F. The die zones are set at 380° F. This produces a lay-flat bubble having a width of 5 in. Layer “B” is a thermoplastic polymer layer. Layer “A” comprises 11% (0.22 mil, 5.5 micron) of the overall film thickness and the layer “B” comprises 89% (1.78 mils, 44.5 micron) of the film thickness. Layer “A” comprises the formulations shown in Table 1, based on the total weight of layer A. Layer “B” comprises the formulations shown in Table 1, based on total weight of layer B. The resins used as shown in Tables 1 and 2 are as follows: LLDPE (available from The Dow Chemical Company under the trade name DOWLEX 2247G LLDPE) having a melt index of 2.3 and density of 0.917 g/cm³; LDPE (available from The Dow Chemical Company under the trade name 681i LDPE) having a melt index of 1.15 and 0.922 g/cm³ and LDPE (available from The Dow Chemical Company under the trade name 535i LDPE) having a melt index of 1.9 and 0.925 g/cm³; EMA resin (28 wt % MA content, melt index of 7, available from Arkema under the trade name LOTRYL™ 28MA07); EAA Resin (20.5 wt % AA content, melt index of 300, available from The Dow Chemical Company under the trade name PRIMACOR™ 5986); and Mica concentrate (a 40% by weight dispersion of mica in HDPE. Commercially available from DuPont Canada Inc. under the trade designation MICAFIL™ 40).

Measure surface roughness (Ra) using a surface texture measurement device obtained from Taylor Hobson Ltd. Of Leicester, England, model SURTRONIC 3+, operate using a standard pickup stylus type 112-1503 and operate at a cut-off length (Lc) of 0.1 inch and an evaluation length of 0.5 in. By definition the surface roughness (Ra) is defined as the arithmetic mean of the departures of the profile from the mean line. Surface roughness measurements were made in both the machine direction (MD) and transverse directions (TD) of the film sample. Results are shown in Table 1.

TABLE 1
Multilayer Film Samples.

| | | | MICAFIL | | Mica | | | | |
|---|---|---|---|---|---|---|---|---|---|
| | | | 40 | | in Total | MD | | TD | |
| | | | Concentrate | Mica | Multi- | Ra for | MD | Ra for | TD |
| | 89 vol % | 11 vol % | in | in | layer | Lc = 0.1 | Ra | Lc = 0.1 | Ra |
| | Layer B | Layer A | Layer B | Layer B | Film | inch | Std | inch | Std |
| Example | Formulation | Formulation | (wt %) | (wt %) | (wt %) | (μin) | Dev | (μin) | Dev |
| 1* | 100% | 60% EMA | 0 | 0 | 0 | 33 | 15 | 60 | 10 |
| | LDPE | 40% EAA | | | | | | | |
| 2* | 95% | 60% EMA | 5 | 2 | 1.8 | 70 | 10 | 80 | 17 |
| | LDPE | 40% EAA | | | | | | | |
| | 5% | | | | | | | | |
| | Micafil 40 | | | | | | | | |
| 3 | 90% | 60% EMA | 10 | 4 | 3.6 | 90 | 17 | 103 | 15 |
| | LDPE | 40% EAA | | | | | | | |
| | 10% | | | | | | | | |
| | Micafil 40 | | | | | | | | |
| 4 | 80% | 60% EMA | 20 | 8 | 7.1 | 87 | 15 | 100 | 10 |
| | LDPE | 40% EAA | | | | | | | |
| | 20% | | | | | | | | |
| | Micafil 40 | | | | | | | | |
| 5 | 70% | 60% EMA | 30 | 12 | 10.7 | 113 | 21 | 140 | 20 |
| | LDPE | 40% EAA | | | | | | | |
| | 30% | | | | | | | | |
| | Micafil 40 | | | | | | | | |
| 6 | 60% | 60% EMA | 40 | 16 | 14.2 | 140 | 10 | 147 | 12 |
| | LDPE | 40% EAA | | | | | | | |
| | 40% | | | | | | | | |
| | Micafil 40 | | | | | | | | |
| 7 | 50% | 60% EMA | 50 | 20 | 17.8 | 133 | 21 | 157 | 12 |
| | LDPE | 40% EAA | | | | | | | |
| | 50% | | | | | | | | |
| | Micafil 40 | | | | | | | | |
| 8* | 100% | 100% | 0 | 0 | 0 | 20 | 0 | 30 | 0 |
| | LDPE | LDPE | | | | | | | |
| 9 | 90% | 100% | 10 | 4 | 3.6 | 73 | 6 | 97 | 12 |
| | LDPE | LDPE | | | | | | | |
| | 10% | | | | | | | | |
| | Micafil 40 | | | | | | | | |
| 10 | 70% | 100% | 30 | 12 | 10.7 | 93 | 21 | 107 | 6 |
| | LDPE | LDPE | | | | | | | |
| | 30% | | | | | | | | |
| | Micafil 40 | | | | | | | | |
| 11 | 50% | 100% | 50 | 20 | 17.8 | 120 | 10 | 107 | 2 |
| | LDPE | LDPE | | | | | | | |
| | 50% | | | | | | | | |
| | Micafil 40 | | | | | | | | |

As shown in the examples, the addition of MICAFIL™ 40 concentrate to multilayer film samples significantly increases film surface roughness.

### Examples 12-15

Each example is a monolayer film sample created as described. Extrude each monolayer film with an overall thickness of 2 mils (50 microns) using a conventional upward blown film line equipped with an 18 inch (in.) (45.7 cm) diameter die and one 4.5 in. (11.4 cm) extruder. Zone ramp the extruder from 310° F. to 340° F. The die zones are set at 350° F. This produces a lay-flat bubble having a width of 61 in. (155 cm). The monolayer film samples comprise the formulations shown in Table 2. The resins used are the same as described in Examples 1-11.

Measure surface roughness (Ra) using a surface texture measurement device obtained from Taylor Hobson Ltd. Of Leicester, England, model SURTRONIC 3+, operated using a standard pickup stylus type 112-1503 and operated at a cut-off length (Lc) of 0.1 inch. Surface roughness measurements were made in both the machine direction (MD) and transverse directions (TD) of the film sample. Results are shown in Table 2.

TABLE 2
Monolayer Film Samples.

| | | | | Mica in | | | | |
|---|---|---|---|---|---|---|---|---|
| | | MICAFIL | | Total | MD | | TD | |
| | | 40 | | Mono- | Ra for | MD | Ra for | TD |
| | | Concentrate | Mica in | layer | Lc = 0.1 | Ra | Lc = 0.1 | Ra |
| | Layer | in Layer | Layer | Film | inch | Std | inch | Std |
| Example | Formulation | (wt %) | (wt %) | (wt %) | (μin) | Dev | (μin) | Dev |
| 12* | 100% | 0 | 0 | 0 | 20 | 0 | 30 | 0 |
| | LDPE | | | | | | | |
| 13 | 75% LDPE, | 25 | 10 | 10 | 130 | 10 | 120 | 10 |
| | 25% | | | | | | | |
| | Micafil 40 | | | | | | | |
| 14 | 42% LDPE, | 30 | 12 | 12 | 220 | 20 | 227 | 15 |
| | 28% | | | | | | | |
| | LLDPE | | | | | | | |
| | 30% | | | | | | | |
| | Micafil 40 | | | | | | | |
| 15 | 39% LDPE, | 35 | 14 | 14 | 173 | 40 | 360 | 17 |
| | 26% | | | | | | | |
| | LLDPE | | | | | | | |
| | 35% | | | | | | | |
| | Micafil 40 | | | | | | | |

As shown in the examples, the addition of MICAFIL™ 40 concentrate to monolayer film samples significantly increase film surface roughness.

Surface roughness data for Layer “A” of the multilayer film sample enables correlation to the amount of mica concentrate in Layer “B” and the amount of mica in the film sample as a whole. As shown, there is a statistically significant correlation, in both the MD and TD, that adding increasing levels of MICAFIL™ 40 to Layer “B” increases the surface roughness of Layer “A”. For comparative example A, which does not contain any mica in Layer B, the parameter of surface roughness Ra is low compared to the films containing mica in Layer B.

Surface roughness data for monolayer film samples enables correlation to the amount of mica concentrate in the film and the amount of mica in the film as a whole. As shown, there is a statistically significant correlation, in both the MD and TD, that adding increasing levels of MICAFIL™ 40 to the monolayer films increases the surface roughness of the film surface. For comparative example B, which does not contain any mica in the film, the parameter of surface roughness Ra is low compared to the films containing mica. Comparative example B was made as a co-extruded multilayer film sample, but since all three layers have the identical formulation, it is considered to also be a monolayer film.

### Examples 1-15 as Applied

Each of the film samples prepared above is applied to each of a number of identical painted metal plates. Each painted metal plate is prepared on 0.155 mm thick electrolytic chrome/chrome oxide coated steel (available from Mitsui & Company, Ltd.), cut to a width of 10 cm and a length of 30 cm, and coated using the following process. Plates are taped on one end to a flat surface. A quantity of Kilz2 interior/exterior water based primer (available from Masterchem Industries) sufficient to coat the full area of the plate is added at a distance of 2.5 cm from the taped end. The primer is spread evenly over the plate using a #34 metering rod (available from RD Specialties). The samples are dried in a 93° C. oven (available from Thermotron, Holland, Mich.) for 30 minutes, cooled to room temperature, coated with exterior acrylic-latex, semi-gloss paint (available from PPG Architectural Finishes, Inc. under the trade name OLYMPIC 64428 base 2 and PPG code 73202) using the same process and metering rod as the primer, dried in a 93° C. oven for 30 minutes, and cooled to room temperature.

Each of the film samples of examples 1-15 are pressed onto each of the painted plate using the following process. Onto a 30 cm by 30 cm steel plate of 3.18 millimeter (mm) thickness are placed two painted plates side by side, about 3 cm apart, the contact side of a 10 cm by 10 cm film sample is placed on the upper third of each painted plate, another film sample in the center third and yet another film sample in the bottom third of each painted plate such that each plate can test three different film samples in one pressing. A 102 micron thick smooth polyester film is placed over the film samples/plates to ensure a smooth surface is pressing on the back of the film samples so that roughness transferred comes only from each of the film samples. A 3.18 mm silicon rubber pad is placed over the polyester film to ensure that pressure distribution is even. A second 30 cm by 30 cm steel plate of 2.4 mm thickness is placed over the rubber pad and the entire assembly is placed in a platen press (made by Pasadena Hydraulics, Inc., Model BL444-6-M2-X2-3-5). The press is closed and held at room temperature at a pressure of 104 psi for 30 minutes, the assembly is removed and the film covered metal plates are removed. Each of the film samples is removed and the painted surface is analyzed for surface roughness and 60° Gloss (BYK-Gardner Inc., Micro-TRI-gloss, Model 4525 tested to ASTM D2457). Results are shown in Table 3. FIG. 3 illustrates the effect that a film in accordance with an embodiment of the present invention has on a painted surface. Reference numeral 4 illustrates a painted metal plate where no film was applied. Reference numeral 5 illustrates the effect that film example 12* has on a painted metal plate. Reference numeral 6 illustrates the effect that film example 13 has on a painted metal plate. Reference numeral 7 illustrates the effect that film example 15 has on a painted metal plate.

TABLE 3
Resulting Effect on Paint Gloss and Paint
Roughness of Painted Metal Plate

| | | Film | Paint | |
|---|---|---|---|---|
| Film Example | Mica in | Roughness | Roughness | Paint 60 |
| on the | Total Film | Ra (μin) | Ra (μin) | deg Gloss |
| Painted Plate | (wt %) | MD | MD | MD |
| 1* | 0 | 33 | 43 | 38 |
| 2* | 1.8 | 70 | 44 | 30 |
| 3 | 3.6 | 90 | 45 | 24 |
| 4 | 7.1 | 87 | 47 | 15 |
| 5 | 10.7 | 113 | 49 | 14 |
| 6 | 14.2 | 140 | 48 | 14 |
| 7 | 17.8 | 133 | 54 | 16 |
| 8* | 0 | 20 | 36 | 52 |
| 9 | 3.6 | 73 | 41 | 38 |
| 10 | 10.7 | 93 | 49 | 13 |
| 11 | 17.8 | 120 | 49 | 16 |
| 12* | 0 | 20 | 36 | 52 |
| 13 | 10 | 130 | 57 | 14 |
| 14 | 12 | 220 | 59 | 11 |
| 15 | 14 | 173 | 67 | 9 |

It is shown that higher filler concentration in the layer results in lower 60° gloss on the painted plate. It is shown that higher surface roughness in the film samples results in higher surface roughness in the painted plate. It is further shown that the lower surface gloss is related to the higher surface roughness of the painted plate.

### Comparative Samples A-G and Example 16

Each of Example 16 and Comparative Samples A-G is a multilayer film sample created as described. Co-extrude each multilayer film having an ABC structure with an overall thickness of 2 mils (50 microns) using a conventional upward blown film line equipped with a 2 inch (in) (5.08 centimeter (cm)) diameter die and three 0.75 in. (1.91 cm) extruders. Zone ramp the extruder that feeds Layer “A” from 350° F. to 380° F. (177-193° C.). Zone ramp the extruder that feeds Layer “B” from 360° F. to 380° F. (182-193° C.). Zone ramp the extruder that feeds Layer “C” from 320° F. to 350° F. (160-177° C.). The die zones are set at 390° F. (199° C.). Layer “A” is a thermoplastic polymer layer of 75 weight percent HDPE and 25 weight percent LLDPE. Layer “A” comprises 10% of the overall film thickness and the layer “B” comprises 75% of the film thickness. Layer “B” comprises 75 weight percent LLDPE and 25 weight percent LDPE. Layer “C” comprises 15 percent of the film thickness and has the formulations shown in Table 4 based on the total weight of Layer C. The resins used Comparative Samples A-D and Example 16 are as follows: HDPE (available from The Dow Chemical Company under the trade name DMDA-8907 NT 7 HDPE) having a melt flow rate (190° C./2.16 kg weight) of 6.75 g/10 minutes and density of 0.954 g/cm³; LLDPE (available from The Dow Chemical Company under the trade name DOWLEX 2247G LLDPE) having a melt index of 2.3 and density of 0.917 g/cm³; LDPE (available from The Dow Chemical Company under the trade name 681i LDPE) having a melt index of 1.15 and 0.922 g/cm³; EMA resin (28 wt % MA content, melt index of 7, available from Arkema under the trade name LOTRYL™ 28MA07); EAA resin (20.5 wt % AA content, melt index of 300, available from The Dow Chemical Company under the trade name PRIMACOR™ 5986); and tackifier (30 weight percent terpene concentrate in LDPE, available from Ampacet Corp. under the trade designation AMPACET™ 103233) (hereinafter terpene concentrate) or acrylic hot melt resin available from Rohm & Haas under the trade name PARALOID™ B-72 acrylic hot melt resin (hereinafter hot melt tackifier).

The resulting multilayer films are laminated to painted metal test panels commercially available from ACT Test Panels LLC under the trade designation APR46671. The test panels are prepared by painting first with an acrylic latex primer commercially available from Valspar Corp. under the trade designation VALSPAR™ 23703, and after the primer is dry, with an acrylic latex topcoat commercially available from Valspar Corp. under the trade designation VALSPAR™ 794812. The painted test panels are dried in an oven for a period of two hours at 200° F. (94° C.). Film samples are laminated to the painted panels (4″×6″ or 10 cm×15 cm) using a heat sealer, commercially available from Sentinel Inc. under the trade designation Model 12-12ASD, at various temperatures indicated in Table 4, with a pressure of 207 KPa and a dwell time of 5 seconds. A temperature-sensitive tape (available from Paper Thermometer Co., Inc. under the trade designation 8-TEMP THERMOLABEL™) is used to confirm the actual lamination temperature. The test panels with laminated films are stored for 3 days in a film testing lab. No delamination is observed. The films are cut into 1 inch (2.54 cm) strips using a blade cutting through the film against the metal panel. A 180° peel test is conducted at room temperature using a tensile test machine commercially available from Illinois Tool Works under the trade designation Instron Model 1123 according to the procedures of ASTM F88. Peel strength of the films laminated at various temperatures is given in Table 4. The peel strengths reported in Table 4 are an average of three repetitions of each measurement.

TABLE 4
Formulation of Layer C and Resulting Peel Strength of Comparative
Samples (CS) A-G and Example (Ex) 16

| | CS A* | CS B* | CS C* | Ex 16 | CS D* | CS E* | CS F* | CS G* |
|---|---|---|---|---|---|---|---|---|
| EMA wt % | 100 | 60 | 60 | 36 | 64 | 70 | 42 | 68 |
| EAA wt % | 0 | 40 | 0 | 24 | 16 | 0 | 28 | 17 |
| terpene | 0 | 0 | 40 (12) | 40 (12) | 20 (6) | 0 | 0 | 0 |
| concentrate | | | | | | | | |
| wt % | | | | | | | | |
| (tackifier %) | | | | | | | | |
| Hot melt | 0 | 0 | 0 | 0 | 0 | 30 | 30 | 15 |
| tackifier % | | | | | | | | |
| Peel strength | 0.015 | 0.01 | 0.55 | 0.14 | 0.035 | 0.011 | 0.016 | 0.022 |
| in lb force, | | | | | | | | |
| laminated at | | | | | | | | |
| 170° F. (77° C.) | | | | | | | | |
| Peel strength | 0.067 | 0.044 | 2.45 | 0.62 | 0.16 | 0.049 | 0.071 | 0.098 |
| in newtons, | | | | | | | | |
| laminated at | | | | | | | | |
| 77° C. | | | | | | | | |
| Peel strength | 0.016 | 0.012 | 0.5 | 0.13 | 0.045 | 0.014 | 0.023 | 0.025 |
| in lb force, | | | | | | | | |
| laminated at | | | | | | | | |
| 190° F. (88° C.) | | | | | | | | |
| Peel strength | 0.071 | 0.053 | 2.22 | 0.58 | 0.20 | 0.062 | 0.10 | 0.11 |
| in newtons, | | | | | | | | |
| laminated at | | | | | | | | |
| 88° C. | | | | | | | | |
| Peel strength | 0.023 | 0.017 | 0.7 | 0.13 | 0.07 | 0.017 | 0.032 | 0.035 |
| in lb force, | | | | | | | | |
| laminated at | | | | | | | | |
| 200° F. (93° C.) | | | | | | | | |
| Peel strength | 0.10 | 0.076 | 3.11 | 0.58 | 0.31 | 0.076 | 0.14 | 0.16 |
| in newtons, | | | | | | | | |
| laminated at | | | | | | | | |
| 93° C. | | | | | | | | |
| Peel strength | 0.024 | 0.014 | 0.73 | 0.16 | 0.04 | 0.015 | 0.035 | 0.044 |
| in lb force, | | | | | | | | |
| laminated at | | | | | | | | |
| 220° F. | | | | | | | | |
| (104° C.) | | | | | | | | |
| Peel strength | 0.11 | 0.062 | 3.25 | 0.71 | 0.18 | 0.067 | 0.16 | 0.20 |
| in newtons, | | | | | | | | |
| laminated at | | | | | | | | |
| 104° C. | | | | | | | | |

Not an example of the invention

The data in Table 4 shows that a broad range of peel strength (0.01-0.73 lbf or 0.044-3.25 newtons) are achieved by varying the level of EAA and tackifier concentrate and the lamination temperature. The film of Example 16 has a proper peel strength for controlled surface adhesion to remain fixed to the substrate surface, to be peelably removable from the surface, and to maintain film surface integrity during removal to avoid leaving an unacceptable adhesive residue as previously disclosed herein. Comparative Samples A, C and E compared with Example 16 show that EAA is important in achieving the desired peel strength. Comparative Samples D and G as compared to Example 16, show that, when used with a tackifier, the weight ratio of EMA to EAA should be less than 4 to achieve a desirable peel strength. Comparative Sample B in compared to Example 16 shows that the tackifier is useful in achieving the desired result.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents. Further, it is to be fully understood that all of the foregoing is intended to be merely illustrative and is not to be construed or interpreted as being restrictive or otherwise limiting of the present invention.

1. A multilayer polymer film for application to and removal from a substrate, having controlled surface adhesion and peelably removable from a surface, the film having a layer comprising components (A) at least one polyolefin, (B) an adhesive composition in an amount equal to or greater than 3 weight percent, (C) a tackifier composition in an amount of from 1 to 12 weight percent, (D) at least one colorant in an amount from 0 to 15 weight percent, (E) anti-block additive in an amount of less than 1 weight percent, and (F) roughening material in an amount of less than or equal to 20 weight percent, each based on total weight of the adhesive layer; the components (A) through (F) with optional incidental carriers and additives being 100 percent by weight of the adhesive layer; wherein the adhesive composition consists essentially of ethylene/methyl acrylate and ethylene/acrylic acid in a weight ratio of from 60:40 to 50:15, that is, 77:23, ethylene/methyl acrylate to ethylene/acrylic acid; the tackifier is selected from a terpene phenolic resin or an acrylic hot melt resin; and the roughening material has an average particle size ranging from 20 to 60 microns.

2. The multilayer polymer film of claim 1 wherein, in the ethylene/methyl acrylate, the ethylene is copolymerized with methyl acrylate in an amount of from 26 to 31 weight percent, based upon copolymer weight.

3. The multilayer polymer film of claim 1 wherein the ethylene/methyl acrylate has a melt index of from 2 to 7.

4. The multilayer polymer film of claim 1 wherein at least one polyolefin is a substantially linear ethylene polymer (SLEP).

5. The multilayer polymer film of claim 1 wherein, in the ethylene/acrylic acid, the ethylene is copolymerized with acrylic acid in an amount of from 6 to 22 weight percent, based upon copolymer weight.

6. The multilayer polymer film of claim 1 wherein, in the ethylene/acrylic acid, the ethylene is copolymerized with acrylic acid in an amount of from 9 to 22 weight percent, based on copolymer weight.

7. The multilayer polymer film of claim 1 wherein the tackifier is a terpene phenolic resin.

8. The multilayer polymer film of claim 1 wherein the adhesive composition is present in an amount of equal to or greater than 10 weight percent based on the total weight of the adhesive layer.

9. The multilayer polymer film of claim 1 wherein the adhesive composition is present in an amount of equal to or greater than 15 weight percent based on the total weight of the adhesive layer.

10. The multilayer polymer film of claim 1 wherein the adhesive composition is present in an amount of equal to or greater than 20 weight percent based on the total weight of the adhesive layer.

11. The multilayer polymer film of claim 1 wherein the roughening material is present in an amount of less than 10 weight percent.

12. The multilayer polymer film of claim 1 additionally comprising at least one backing layer.

13. The multilayer polymer film of claim 12 wherein the backing layer comprises at least one polyolefin having a sufficiently high melting point to prevent sticking of the backing layer to a hot surface.

14. The multilayer polymer film of claim 1 additionally comprising at least one polymer film layer including a base polyolefin and roughening material.

15. The multilayer polymer film of claim 14 on a relatively soft or malleable surface of a substrate.

16. The multilayer polymer film of claim 15 wherein the relatively soft or malleable surface of a substrate is selected from thermoplastics or thermosettable plastics or a coating applied to a substrate.

17. The multilayer polymer film of claim 16 wherein the coating is paint or freshly applied paint.

18. The multilayer polymer film of claim 1 on a relatively soft or malleable surface of a substrate.

19. The multilayer polymer film of claim 18 wherein the relatively soft or malleable surface of a substrate is selected from thermoplastics or thermosettable plastics or a coating applied to a substrate.

20. The multilayer polymer film of claim 19 wherein the coating is paint or freshly applied paint.
